(19) United States
(12) Patent Application Publication
(10) Pub. No.: US 2015/0001044 A1
(43) Pub. Date: Jan. 1, 2015

(54) MACHINE FOR FORMING A LAYER OF OBJECTS AND RELATED METHOD

(71) Applicant: EMMETI S.P.A., Montecchio Emilia, REGGIO EMILIA (IT)

(72) Inventor: Luca Abretti, Montecchio Emila (IT)

(73) Assignee: Emmeti S.p.A., Montecchio Emilia, Reggio Emilia (IT)

(21) Appl. No.: 14/369,643

(22) PCT Filed: Dec. 27, 2012
(86) PCT No.: PCT/IB2012/057758

§ 371 Date: Jun. 27, 2014

(30) Foreign Application Priority Data
Dec. 29, 2011 (IT) MI2011A002429

(51) Int. Cl. B65G 15/22; B65G 47/26

(52) U.S. Cl. CPC B65G 15/22; B65G 47/26
USPC 198/575

(57) ABSTRACT

Machine (100) for forming a layer of objects, comprising: a belt (1) for conveying objects (2), having a forward movement direction (D1); means (6) for counting objects moving forward on the conveyor belt (1); means (7) for moving the objects (2) forward on the conveyor belt 1, said moving means (7) being configured to allow/prevent the objects (2) from passing from a first forward moving area (Z1) to a second forward moving area (Z2), based on the information provided by the counting means (6), said moving means (7) being configured to translate from a first operational position to a second operational position, and to translate from the second operational position to a third operational position.

The present invention relates to palletization techniques of objects, and particularly to a machine for forming a layer of objects and related method.

Machines for forming a layer of objects, such as glass, ceramic, or plastic bottles or vases, cans, jars, and so on, are known.

Such forming machines typically comprise a conveyor belt of objects having a main forward movement direction to bring, on one or more lines, unpackaged objects to be palletized coming from a supply area, arranged upstream of the machine for forming a layer of objects, to a forming area of the layer of objects. Between the supply area and the forming area of a layer of objects, the forming machines generally comprise a forming area of rows of objects to be provided to the layer forming area, in which the rows of objects are mutually arranged side by side to form a layer of objects.

The forming area of the rows of objects is typically composed of a photocell counting the objects moving on the conveyor belt and by a mechanical cylinder configured to be inserted orthogonally to the forward movement direction of the conveyor belt to stop the forward movement of the objects and to separate the newly formed row of objects entering the forming area of the layer of objects from the next row of objects. The mechanical cylinder is inserted when the photocell has counted the number of objects of a row to be formed, and it is withdrawn when the formation of a successive row is started. When the forward movement of the objects is stopped, the insertion of the mechanical cylinder can damage the first object remaining upstream of the forming area of rows of objects. Furthermore, the abrupt stop of the objects moving forward may nevertheless generally cause damages to more than one object that, due to the moving speed of the conveyor belt, which is not reduced, may abruptly collide together and possibly break.

In order to avoid this, the moving speed of the conveyor belt can be decreased. However, it shall be apparent that this involves a yield reduction, thus, a productive loss of the whole machine for forming a layer of objects.

In another machine for forming a layer of objects of a known type, the forming area of rows of objects, in the case that the objects are without a neck (e.g., vases or jars), which cannot be counted by a photocell, is typically composed of a so-called “star-shaped” element freely rotating about its rotational axis, orthogonal to a reference plane on which the machine (e.g., the floor) rests, and it is mounted at the conveyor belt so that it can surround and move with each of the objects moving on the conveyor belt.

The star-shaped element is provided with both a sensor, in order to count the number of objects moving forward on the conveyor belt, and a pneumatic cylinder to stop the free rotation of the star-shaped element about its rotational axis. The rotational stop occurs when the sensor has counted a number of objects corresponding to the row to be formed, whereby it is necessary to stop the forward movement of further objects so as to separate the formed row entering the forming area of a layer of objects from the row of objects upstream of the forming area of rows of objects.

However, in this case also, the abrupt stop of the star-shaped element can involve abrupt collisions between objects arranged at the star-shaped element, and generally between the objects arranged upstream of the forming area of rows of objects, with a damaging or breaking risk for the same objects, also due to the forward movement speed of the conveyor belt, which is not reduced.

In order to obviate this drawback, the moving speed of the conveyor belt could be reduced; however, it is apparent that this could go to the detriment of the yield of the machine for forming a layer of objects, thus of its production yield. Object of the present invention is to provide a machine for forming a layer of objects allowing at least partially obviating the drawbacks set forth herein before with reference to the prior art, and particularly allowing maintaining the moving speed of the conveyor belt substantially constant, thus maintaining the yield and production of the same forming machine to an optimum level.

Such an object is achieved by a machine for forming a layer of objects in accordance with claim 1.

Preferred embodiments of such a machine are defined in the dependent claims 2-9.

It is an object of the present invention also a method for forming a layer of objects in accordance with claim 10, and preferred embodiments thereof, as defined in the dependent claims 11-12.

Further characteristics and advantages of the machine for forming a layer of objects according to the invention will be apparent from the description set forth below of preferred embodiments, given by way of non-limiting, illustrative example, with reference to the appended Figures, in which:

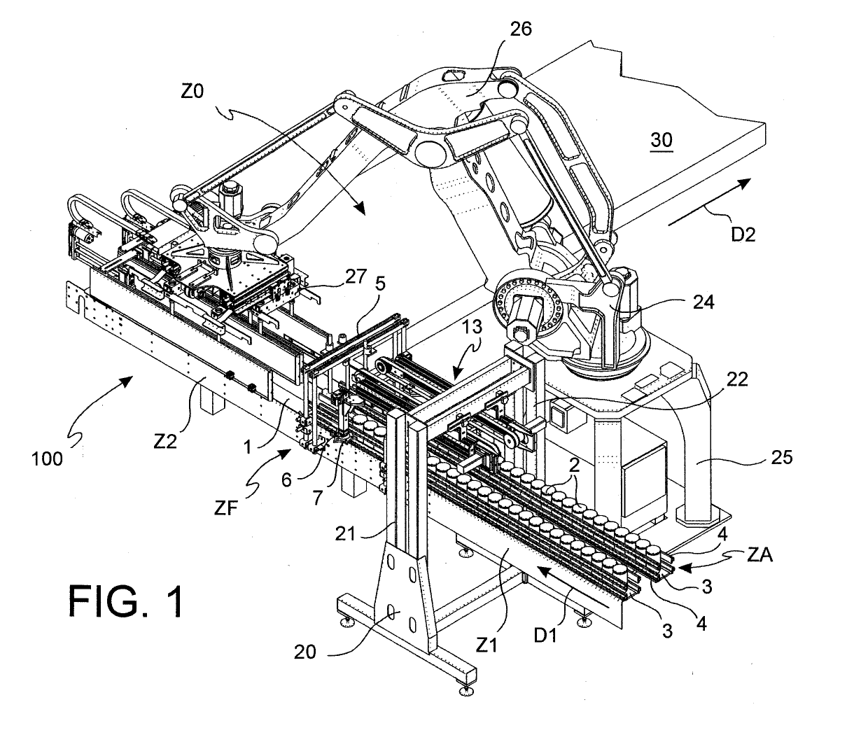

FIG. 1 illustrates a perspective view of a machine for forming a layer of objects according to an example of the invention;

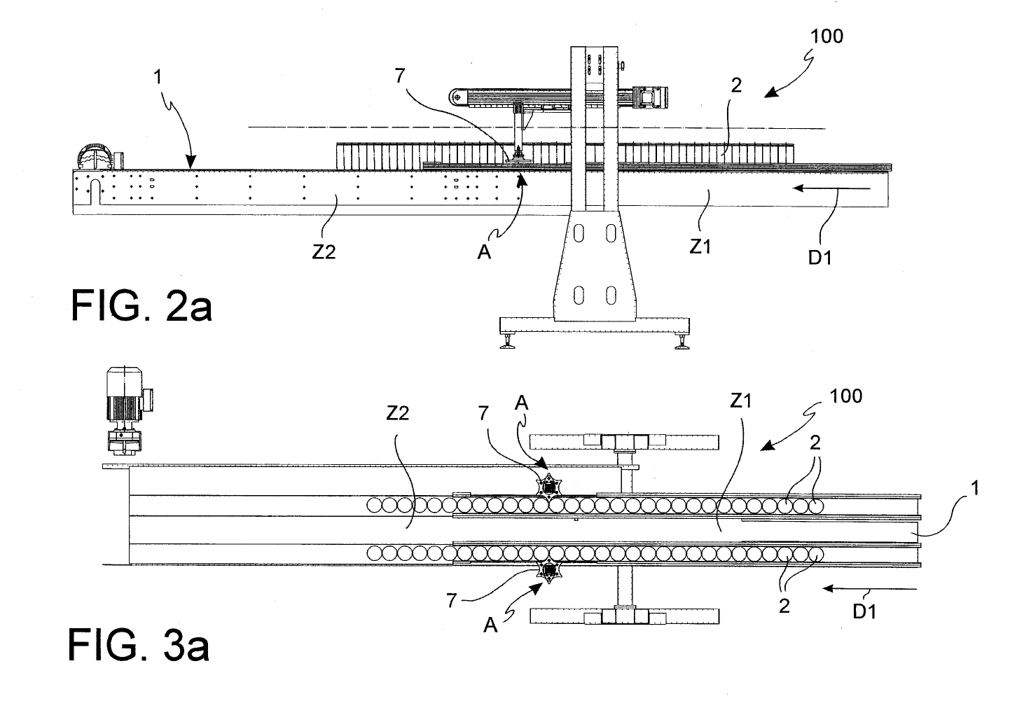

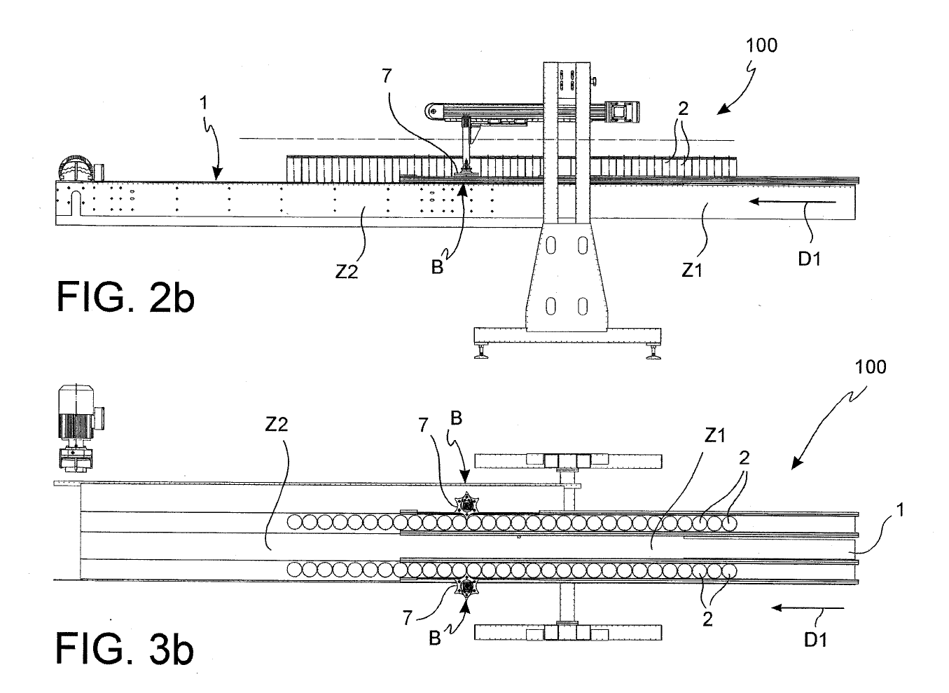

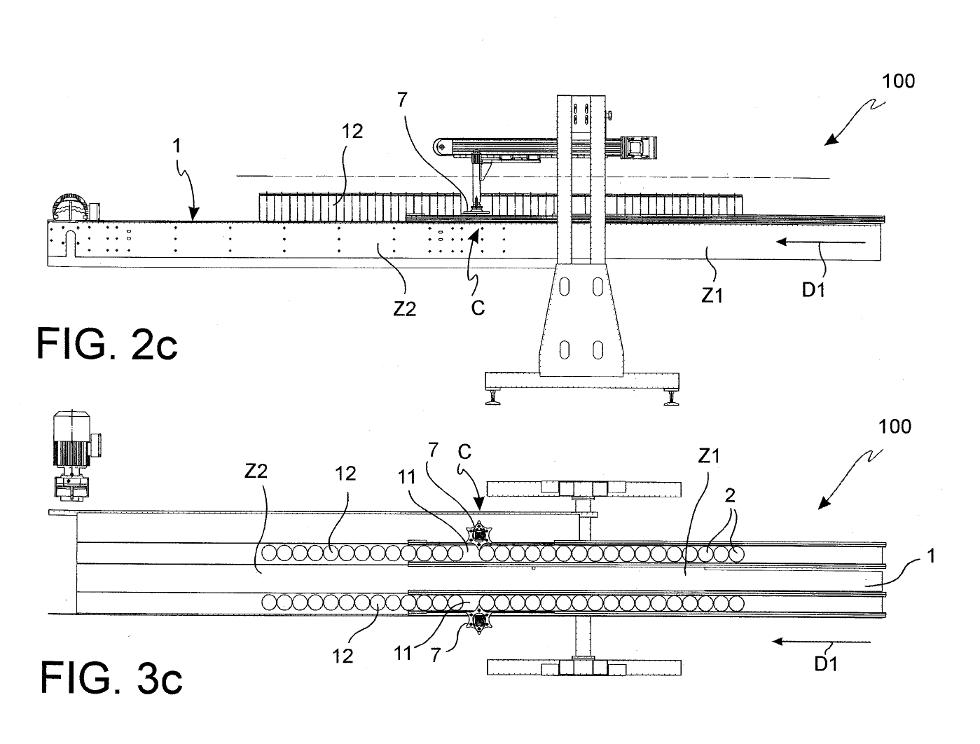

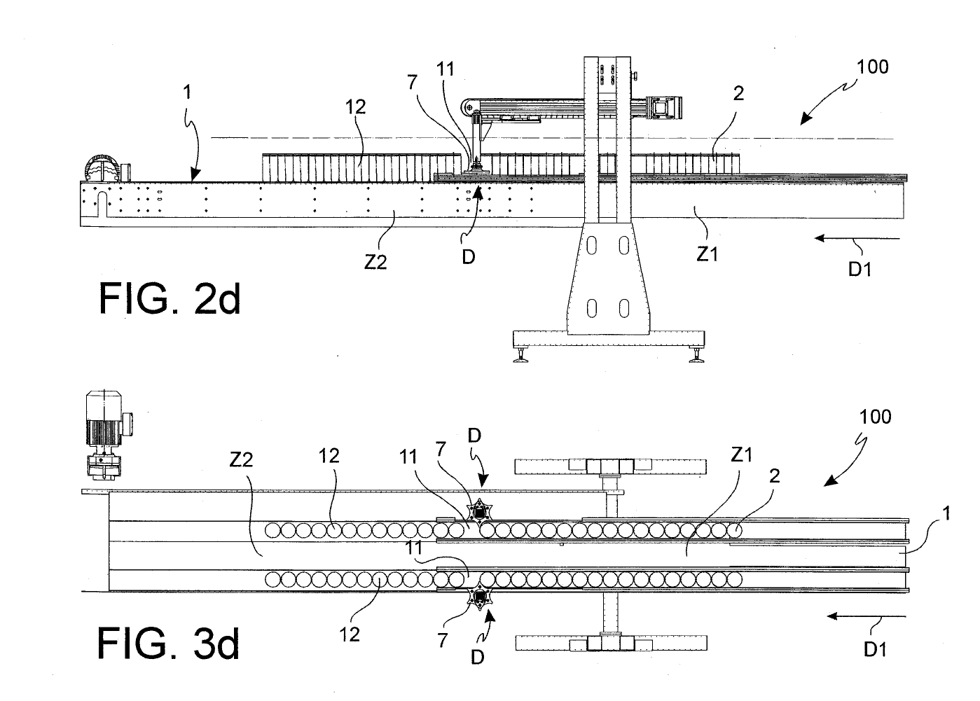

FIGS. 2a, 3a, 4a, illustrate a side view, a sectional view along a plane parallel to a reference plane on which the machine rests, and a perspective view, respectively, of a portion of the machine of FIG. 1, in a first operational configuration;

FIGS. 2b, 3b, 4b, illustrate a side view, a sectional view along a plane parallel to a reference plane on which the machine rests, and a perspective view, respectively, of a portion of the machine of FIG. 1 in a second operational configuration;

FIGS. 2c, 3c, 4c, illustrate a side view, a sectional view along a plane parallel to a reference plane on which the machine rests, and a perspective view, respectively, of a portion of the machine of FIG. 1 in a third operational configuration;

FIGS. 2d, 3d, 4d, illustrate a side view, a sectional view along a plane parallel to a reference plane on which the machine rests, and a perspective view, respectively, of a portion of the machine of FIG. 1 in a fourth operational configuration;

FIGS. 2e, 3e, 4e, illustrate a side view, a sectional view along a plane parallel to a reference plane on which the machine rests, and a perspective view, respectively, of a portion of the machine of FIG. 1 still in the first operational configuration;

FIG. 5 illustrates a perspective view of an enlargement of a portion of the forming machine of FIG. 1; and

FIG. 6 illustrates a perspective view of an enlargement of a further reference portion of the forming machine of FIG. 1.

With reference to the above-mentioned Figures, a forming machine 100 of a layer of objects, herein below also referred to as a forming machine, or simply machine, according to an example of the invention will be now described.

It is pointed out that, in the above-mentioned Figures, like elements are indicated by the same numeral references. However, numeral references of some elements are omitted in some Figures for the sake of simplicity, since they are considered as not necessary.

To the aim of the present description, with objects are meant bottles, cans, jars, vases or generally glass, ceramic, or plastic containers, and so on.

With reference generally to FIG. 1, the forming machine 100 comprises a belt 1 for conveying objects 2 having a forward movement direction D1. The conveyor belt 1 is configured to move with a respective operational moving speed. Examples of values for the operational moving speed of the conveyor belt 1 range between 1-100 meters per minute. A typical value used is 30 mpm.

The conveyor belt 1 is configured to transport objects 2 coming from a supply area, indicated in Fig. with the reference ZA, on one or more conveying lines 3. Such one or more conveying lines 3 are defined by a plurality of walls 4 extending parallel to the forward movement direction of the conveyor belt 1.

It shall be noticed that the forming machine 100 comprises a mechanical group 5 adapted to allow the selection of both the number of walls according to the number of conveying lines to be employed, and the width between two adjacent walls according to the width of the objects to be conveyed. The mechanical group 5 comprises rods arranged both transversally to the forward movement direction of the belt, and perpendicular to a plane corresponding to a reference plane on which the forming machine 100 (e.g., a floor) rests, referred to herein below also simply as a support surface of the forming machine 100. The rods of the mechanical group 5 are adjusted and screwed by screws and levers.

In the example of the figures, the conveyor belt 1 is configured to transport the objects 2 on two conveying lines, both of which being indicated with the numeral reference 3. Referring back generally to the forming machine 100, it comprises means 6 for counting objects moving on the conveyor belt 1, operationally associated to the conveyor belt 1. The counting means 6 are configured to provide information representative of the number of objects moving on the conveyor belt 1.

Furthermore, the forming machine 100 comprises means 7 for moving the objects 2 on the conveyor belt 1 (herein below also simply moving means 7), operationally associated to the conveyor belt 1 to define a first forward moving area Z1 and a second forward moving area Z2 of the objects on the conveyor belt 1. It shall be noticed that the forward movement direction D1 of the conveyor belt 1 is such as to convey the objects 2 from the first forward moving area Z1 to the second forward moving area Z2. In other terms, the first forward moving area Z1 is arranged upstream of the moving means 7, while the second forward moving area Z2 is arranged downstream of the moving means 7. The moving means 7 are configured to allow/prevent the objects from passing from the first forward moving area Z1 to the second forward moving area Z2, based on the above-mentioned information provided by the counting means 6.

With particular reference to the FIGS. 5 and 6, an embodiment of the counting means 6 and the moving means 7 is provided.

It is pointed out that respective counting means 6 and respective moving means 7 correspond to each conveying line 3 of the conveyor belt 1. In the following description, the counting means 6 and the moving means 7 corresponding to one of the two conveying lines 3 of the conveyor belt 1 will be described. What has been indicated for a conveying line also applies to the other conveying line, and generally to each further conveying line, where present, of the conveyor belt 1. In accordance to this embodiment, the moving means 7 comprise a star-shaped element having the respective surface extending parallel to the support surface of the machine 100.

The star-shaped element comprises a plurality of tips, in which adjacent tips are mutually connected by a respective concave profile. The star-shaped element is configured to freely rotate about a respective rotational axis passing through the center of the star-shaped element and orthogonal to the support surface of the machine 100.

The star-shaped element is located, transversally to the forward movement direction of the conveyor belt 1, at a point such that each concave profile of the star-shaped element engages with an object moving on the conveyor belt 1 and the star-shaped element can freely rotate, thus promoting the forward movement of the objects 2 on the conveyor belt 1.

In accordance with this embodiment, the moving means 7 comprise a pneumatic cylinder 8 configured to slide a pin of the star-shaped element, in an orthogonal direction to the support surface of the machine 100 within a respective housing 9 in order to engage with the star-shaped element and to lock the free rotation about the respective rotational axis. Locking/unlocking the rotation of the star-shaped element is implemented in allowing/preventing the objects 2 from passing from the first forward moving area Z1 of the conveyor belt 1 to the second forward moving area Z2 of the conveyor belt 1.

As regards the counting means 6, in the embodiment of the figure, they comprise an optical sensor configured to detect the passage, under the light beam, of respective targets 10 arranged on the surface of the star-shaped element during the free rotation of the star-shaped element about its rotational axis. Each of the targets 10 is distributed on the surface of the star-shaped element at each of the tips. It is noticed that every time the optical sensor detects the passage of one of the targets 10, the star-shaped element has performed a portion of free rotation about its rotational axis corresponding to the passage, at the star-shaped element, of one of the objects 2 moving on the conveyor belt 1.

In a further embodiment, not shown in the figures, the counting means 6 comprise a photocell and a respective target, arranged on opposite sides with respect to the conveying line 3 of the objects 2 moving forward on the conveyor belt 1. The interruption of the light beam between photocell and targets by an object moving on the conveyor belt allows the photocell of detect the passage of an object.

In accordance with this embodiment, the moving means 7 comprise a pneumatic cylinder, actuated by a respective electric motor, configured to slide transversally to the forward movement direction of the objects 2 on the conveyor belt 1 and to insert within the respective conveying line. As the pneumatic cylinder slides coming nearer to the conveyor belt 1, it inserts between an object and the other one, thus interrupting the forward movement on the conveyor belt, preventing the objects from passing from the first forward moving area Z1 to the second forward moving area Z2 of the conveyor belt 1. Instead, as the pneumatic cylinder slides away from the conveyor belt 1, it allows the passage of the objects from the first forward moving area Z1 to the second forward moving area Z2 of the conveyor belt 1.

Referring back generally to the forming machine 100 of the example of the figures, and in particular to the FIGS. 2a, 3a, 4a and 2b, 3b, 4b, the moving means 7 are configured to translate, according to a respective movement speed, along the forward movement direction D1 of the conveyor belt 1 from a first operational position A (FIGS. 2a, 3a, 4a) to a second operational position B (FIGS. 2b, 3b, 4b) in the forward movement direction of the objects 2 on the conveyor belt 1, bringing the respective movement speed from a substantially zero value to a value equal to the moving speed of the conveyor belt 1, for example, 30 mpm.

This advantageously allows preventing the objects 2 from passing from the first forward moving area Z1 to the second forward moving area Z2 of the conveyor belt 1, thereby preventing the objects upstream of the moving means 7 (those in the first forward moving area Z1), at the actuation thereof, from being damaged on the conveyor belt 1.

In fact, it is noticed that the moving means 7 are configured to prevent the objects 2 from passing from the first forward moving area Z1 to the second forward moving area of the conveyor belt 1, based upon the information provided by the counting means, when the moving means 7 are in the second operational position B.

It is pointed out that the lock of the moving means, which prevents the objects 2 from passing from the first forward moving area Z1 to the second forward moving area Z2 of the conveyor belt 1, occurs when the counting means 6 have provided information representative of a number of objects moving forward on the conveyor belt, downstream of the moving means 7, corresponding to the number of objects constituting a row of the layer of objects being formed.

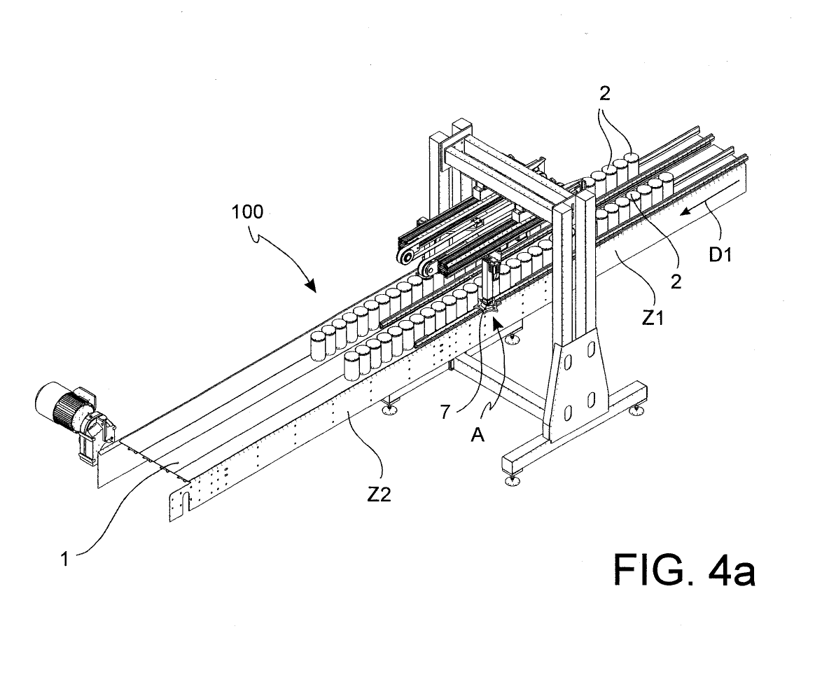

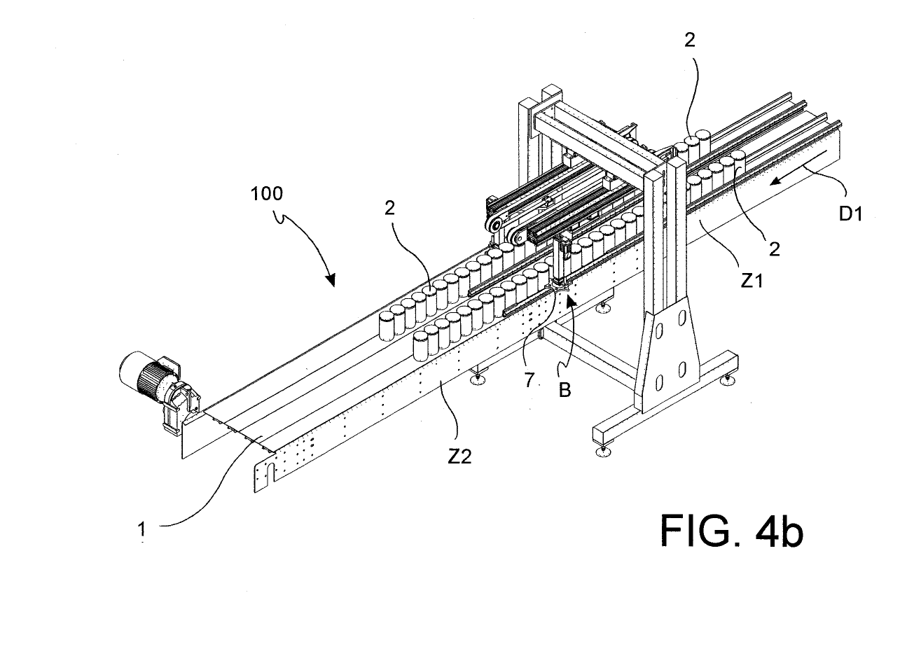

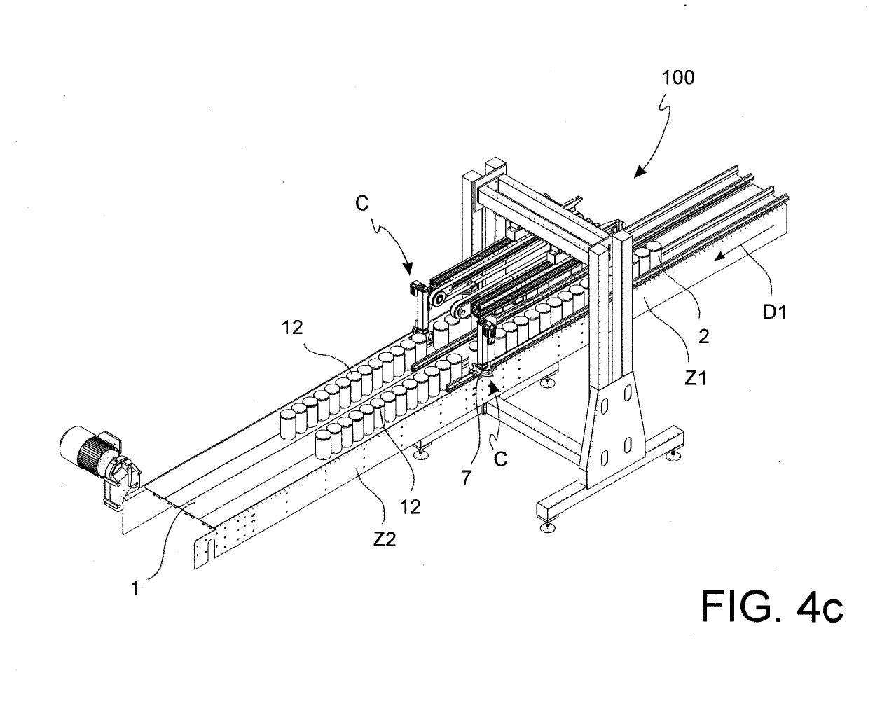

Furthermore, now referring in particular also to the FIGS. 2c, 3c, 4c, the moving means 7 are configured to translate, along the forward movement direction D1 of the conveyor belt 1, from the second operational position B (FIGS. 2b, 3b, 4b) to a third operational position C (FIGS. 2c, 4c, 4c), bringing the respective movement speed from a value substantially equal to the operational moving speed of the conveyor belt 1 to a value substantially lower than said operational moving speed of the conveyor belt 1. Such a value can be for example of about 20 mpm. In other cases, this value can also be null.

This advantageously allows creating a space 11 between the last of the objects downstream of the moving means 7 and the first of the objects upstream of the moving means 7 in order to allow the conveyor belt 1 to convey, downstream of the moving means 7, a row of objects 12 to be added to the layer of objects being formed. The function of this space 11 created between the objects 2 moving on the conveyor belt will be described herein below.

It shall be noticed that the formation of the row of objects 12 is advantageously obtained without reducing the moving speed of the conveyor belt 1, therefore without compromising the production yield of the forming machine 100.

Again, it is pointed out that the translation of the moving means 7 from the second operational position B to the third operational position C advantageously occurs without changing the operational moving speed of the conveyor belt 1.

Furthermore, with particular reference also to the FIGS. 2d, 3d, 4d, the moving means 7 are also configured to translate, along the forward movement direction D1 of the conveyor belt 1, from the third operational position C (FIGS. 2c, 3c, 4c) to a fourth operational position D (FIGS. 2d, 3d, 4d), in the forward movement direction of the objects 2 on the conveyor belt 1, bringing the respective movement speed from the value lower than the operational moving speed of the conveyor belt 1 to a value substantially equal to the operational moving speed of the conveyor belt 1.

This advantageously allows the objects to pass again from the first forward moving area Z1 to the second forward moving area Z2 on the conveyor belt 1, thus avoiding that the objects upstream of the moving means 7, when actuating the moving means 7, may fall on the conveyor belt 1 or even from the conveyor belt 1.

In fact, it is reaffirmed that the moving means 7 are configured to allow the objects to pass from the first forward moving area Z1 to the second forward moving area Z2 of the conveyor belt 1.

It is pointed out that the unlock of the forward movement of the objects 2 on the conveyor belt 1 occurs when the row of objects 12 downstream of the moving means 7 is at a sufficient distance from the first object arranged upstream of the moving means 7.

Again, it is pointed out that the translation of the moving means 7 from the third operational position C to the fourth operational position D advantageously occurs without changing the operational moving speed of the conveyor belt 1.

Referring now particularly also to the FIGS. 2e, 3e, 4e, it is noticed that the moving means 7 are further configured to translate, along the forward movement direction D1 of the conveyor belt 1, in the opposite direction to the forward movement direction of the objects 2 on the conveyor belt 1, from the fourth operational position A (FIGS. 2d, 3d, 4d) to the first operational position A (FIGS. 2e, 3e, 4e).

It shall be noticed that the moving means 7 are configured to translate from the fourth operational position D to the first operational position A, thus bringing the respective movement speed from a value equal to the moving speed of the conveyor belt 1 to a substantially zero value.

In more detail, the moving means 7 are configured to translate, along the forward movement direction D1 of the conveyor belt, in the forward movement direction of the objects, from the fourth operational position D to a further operational position (not shown in the figures), thus bringing the respective movement speed from a value equal to the moving speed of the conveyor belt 1 to a substantially zero value. Furthermore, such moving means 7 are configured to translate, along the forward movement direction D1 of the conveyor belt 1, in the opposite direction to the forward movement direction of the objects 2, from the further operational position to the first operational position A.

It is advantageously noticed that the translation from the fourth operational position D to the first operational position A also occurs without changing the operational moving speed of the conveyor belt 1.

Now referring in particular to the FIGS. 1, 5, and 6, it is pointed out that the forming machine 100 comprises a translation group 13 of the moving means 7.

In more detail, such a translation group 13 comprises at least one translation axis 14 operationally associated to the moving means 7, having a longitudinal development direction parallel to the forwarding movement direction D1 of the conveyor belt 1. It is pointed out that the translation group 13 comprises a number of translation axes 14 equal to the number of the conveying lines 3 of objects of the conveyor belt 1. Furthermore, it is noticed that the number of conveying lines 3 of objects of the conveyor belt 1 also determines the number of counting means 6 and of moving means 7 with which the forming machine 100 has to be provided.

Referring back to the translation group 13, the translation axis 14 comprises a supporting element 15 provided with translation mechanism 16, for example, a belt-pulleys mechanism. The translation group 13 further comprises a connecting element 17 of the moving means 7 to the translation mechanism 16, in the example of the figures, to the belt of the belt-pulleys mechanism. In this regard, it is pointed out that the translation group 13 further comprises an arm 18 extending orthogonally to the support surface of the forming machine 100 having an end constrained to the connecting element 17, and a free end on which the moving means 7 are mounted. In the example of the figures, the moving means 7 are the star-shaped element that is mounted at the arm 18 free end.

It is pointed out that the translation of the moving means 7 is obtained by actuating the translation mechanism 16 by an actuating unit 19 (e.g., a brushless electric motor) with which the translation group 13 (as clearly illustrated in FIG. 6) is provided.

The translation group 13 further comprises a support 20, also resting on the support surface of the forming machine 100. The support 20 comprises a first and a second pair of uprights 21 and 22 extending vertically to the support surface of the forming machine 100 on either respective side of the conveyor belt 1.

The translation group 13 further comprises a pair of supporting bars 23 adapted to connect together the free ends of the first pair of uprights 21 to the free ends of the second pair of uprights 22.

The pair of supporting bars 23 is preferably arranged transversally to the forward movement direction D1 of the conveyor belt and parallel to the support surface of the forming machine 100.

The translation axis 14 is operationally connected, through mechanisms of a known type, to the pair of supporting bars 23.

Referring again to FIG. 1, the forming machine 100 further comprises a handling unit 24 of rows of objects.

Such a handling unit 24 comprises a supporting base 25 arranged on the support surface of the forming machine 100. The handling unit 24 further comprises an robotic arm 26 having an end constrained to the supporting base 25, and a free end on which a translation unit 27 of rows of objects formed downstream of the moving means 7 is mounted.

The translation unit 27 of rows of objects is configured to surround from the top one or more rows of objects, arranged downstream of the moving means 7, with respective walls parallel to the forward movement direction D1 of the conveyor belt 1 and translating the rows of objects from the conveyor belt 1 to a further conveyor belt 30 of rows of objects, having a forward movement direction D2 orthogonal to the forward movement direction D1 of the conveyor belt 1 and parallel to the support surface of the forming machine 100. The forming machine 100 is configured to form the layer of objects on the further conveyor belt 30.

It shall be noticed that the space 11 created between the rows of objects advantageously allows the translation unit 27 of rows of objects to surround from the top and to translate the formed row of objects without affecting the first object of the next row being formed.

It is pointed out that also the configuration of the translation unit 27, the number of walls, and the distance between adjacent walls, depend on the number of conveying lines 3 of objects of the conveyor belt 1 and the size of the objects.

Also, referring again to the FIG. 1, it is pointed out that, beside the supply area ZA (already defined above), the conveyor belt 10, the translation group 13, the moving means 7, and the counting means 6 represent in the forming machine 100′ a forming area ZF of the rows of objects, while the handling unit 24 of the rows of objects and the further conveyor belt 30 represent a forming area ZO of a layer of objects.

Finally, it shall be noticed that the forming machine 100 comprises a data processing unit (e.g., a electronic computer, or a PLC) configured to be operationally connected to, and to control each of the automated components described above in the operation of the forming machine 100.

Again, referring now to the above-mentioned Figures, a method for forming a layer of objects, herein below also simply referred to as a method for forming, or method, will be described according to an example of the present invention.

As already stated, the objects 2 are moving forward on a conveyor belt 1 having a forward movement direction D1. The conveyor belt 1 has a respective operational moving speed.

The method for forming comprises a step of providing, by means of counting means 6 operationally associated to the conveyor belt 1, information representative of the number of objects 2 moving on the conveyor belt 1.

Next, the method for forming comprises a step of providing moving means 7 of the objects 2 on the conveyor belt 1 operationally associated to the conveyor belt 1 to define a first forward moving area Z1 and a second forward moving area Z2 of the conveyor belt. The forward movement direction D1 of the conveyor belt 1 is such as to convey the objects from the 25′ first forward moving area Z1 to the second forward moving area Z2. The moving means 7 are configured to allow/prevent the objects from passing from the first forward moving area Z1 to the second forward moving area Z2, based on the above-mentioned information provided by the counting means 6.

Next, the method further comprises a step of translating said moving means 7, along the forward movement direction D1 of the conveyor belt 1, in the forward movement direction of the objects 2 on the conveyor belt 1, from a first operational position A (FIGS. 2a, 3a, 4a) to a second operational position B (FIGS. 2b, 3b, 4b), bringing the movement speed of the moving means 7 from a value substantially equal to zero to a value substantially equal to the operational moving speed of the conveyor belt.

Next, when the moving means 7 are in the second operational position B, the method comprises the step of preventing, through said moving means 7, the objects 2 from passing from the first forward moving area Z1 to the second forward moving area Z2 of the conveyor belt 1, based upon the information provided by the counting means 6.

Furthermore, the method comprises the step of translating the moving means 7, along the forward movement direction D1 of the conveyor belt 1, in the forward movement direction of the objects 2 on the conveyor belt 1, from the second operational position B (FIGS. 2b, 3b, 4b) to a third operational position C (FIGS. 2c, 3c, 4c), bringing the movement speed from the value substantially equal to the operational moving speed of the conveyor belt 1 to a value lower than said operational moving speed of the conveyor belt 1.

It shall be noticed that the method for forming further comprises a step of translating said moving means 7, along the forward movement direction D1 of the conveyor belt 1, in the forward movement direction of the objects 2 on the conveyor belt 1, from the third operational position C (FIGS. 2c, 3c, 4c) to a fourth operational position D (FIGS. 2d, 3d, 4d), bringing the movement speed from the value lower than the operational moving speed of the conveyor belt to the operational moving speed of the conveyor belt.

Furthermore, when the moving means are in the fourth operational position D, it is noticed that the method for forming further comprises the steps of: allowing, through the moving means 7, the passage of the objects 2 from the first forward moving area Z1 to the second forward moving area Z2 of the conveyor belt; translating the moving means 7, along the forward movement direction D1 of the conveyor belt 1, in the opposite direction to the forward movement direction of the objects on the conveyor belt 1, from the fourth operational position D (FIGS. 2d, 3d, 4d) to the first operational position A (FIGS. 2e, 3e, 4e).

It shall be noticed that the latter step of translating of the moving means 7 from the fourth operational position D (FIGS. 2d, 3d, 4d) to the first operational position A comprises the step of bringing the movement speed of the moving means from a value equal to the operational forward movement speed of the conveyor belt 1 to a substantially zero value.

In more detail, the method comprises the step of translating the moving means 7, along the forward movement direction D1 of the conveyor belt 1, in the forward movement direction of the objects, from the fourth operational position D to a further operational position (not shown in the figures), bringing the respective movement speed from a value equal to the moving speed of the conveyor belt 1 to a substantially zero value. Next, the method comprises the step of translating the moving means 7, along the forward movement direction D1 of the conveyor belt 1, in the opposite direction to the forward movement direction of the objects 2, from the further operational position to the first operational position A.

It shall be noticed that the steps of the method described above are advantageously carried out without reducing the operational moving speed of the conveyor belt 1, therefore not compromising the production yield of the forming machine 100. As it can be verified, the object of the present invention is achieved in that, as iterated before, the machine for forming a layer of objects as described, and the related method allow forming rows of objects, in contrast with the described prior art, without reducing the operational moving speed of the conveyor belt 1, thus without decreasing the output of the machine.

Furthermore, the fact that the moving means 7 are configured to reduce the movement speed of the moving means 7, while keeping the operational moving speed of the conveyor belt 1 unaltered, allows creating between successive rows of objects a space suitable to promote the translation of a row of objects downstream of the moving means without damaging the successive row upstream.

Finally, the fact that the moving means 7 are configured to bring the movement speed of the moving means 7 to the operational moving speed of the conveyor belt 1 before actuating the moving means to lock or unlock the forward movement of the objects on the conveyor belt 1, advantageously allows avoiding abrupt collisions for the objects and possible falls of the objects in the proximity of the moving means, and generally decreasing the chance of abrupt collisions on the objects upstream of the moving means coming from the supply area of the forming machine.

To the embodiments of the machine for forming a layer of objects and of the related method as described above, those of ordinary skill in the art, in order to meet contingent needs, will be able to make modifications, adaptations, and replacements of elements with other functionally equivalents, without departing from the scope of the following claims. Each of the characteristics described as belonging to a possible embodiment can be implemented independently from the other embodiments described.

1. Machine for forming a layer of objects, comprising:
a belt for conveying objects having a forward movement direction, said conveyor belt having a respective operational moving speed;
means for counting objects moving on the conveyor belt, said counting means being configured to provide information representative of the number of objects moving on the conveyor belt;
means for moving the objects forward on the conveyor belt, operationally associated to the conveyor belt to define a first forward moving area and a second forward moving area of the objects on the conveyor belt, the forward movement direction of the conveyor belt being such as to convey the objects from the first forward moving area to the second forward moving area, said moving means being configured to allow/prevent the objects from passing from the first forward moving area to the second forward moving area, based on the above-mentioned information provided by the counting means,
characterised in that said moving means are configured to translate, according to a respective movement speed, along the forward movement direction of the conveyor belt, from a first operational position to a second operational position in the forward movement direction of the objects on the conveyor belt, bringing the respective translation speed from a substantially zero value to a speed equal to the moving speed of the conveyor belt,
said moving means being configured to translate, along the forward movement direction of the conveyor belt, from the second operational position to a third operational position, bringing the respective translation speed from a value substantially equal to the operational moving speed of the conveyor belt to a value substantially lower than said operational moving speed of the conveyor belt.

2. Forming machine according to claim 1, wherein said moving means are further configured to translate, along the forward movement direction of the conveyor belt from the third operational position to a fourth operational position, in the forward movement direction of the objects on the conveyor belt, bringing the respective translation speed from the value lower than the operational moving speed of the conveyor belt to a value substantially equal to the operational moving speed of the conveyor belt.

3. Forming machine according to claim 2, wherein the moving means are further configured to translate, along the forward movement direction of the conveyor belt, in the opposite direction to the forward movement direction of the objects on the conveyor belt, from the fourth operational position to the first operational position.

4. Forming machine according to claim 1, wherein the moving means are further configured to prevent the objects from passing from the first forward moving area to the second forward moving area of the conveyor belt based upon the information provided by the counting means, when the moving means are in the second operational position.

5. Forming machine according to claim 1, wherein the moving means are configured to allow the objects to pass from the first forward moving area to the second forward moving area of the conveyor belt, based upon the information provided by the counting means, when the moving means are in the fourth operational position.

6. Forming machine according to claim 1, further comprising a translation group comprising a translation axis operationally associated to the moving means having a longitudinal development direction parallel to the forward movement direction of the conveyor belt.

7. Forming machine according to claim 6, wherein the translation axis comprises a supporting element provided with a translation mechanism.

8. Forming machine according to claim 7, wherein the translation group comprises an element for connecting the moving means to the translation mechanism, the translation group comprising an arm extending orthogonally to a support surface of the forming machine, having an end constrained to the connecting element and a free end on which said moving means are mounted.

9. Forming machine according to claim 8, wherein the translation group further comprises a support comprising a first and a second pair of uprights, extending vertically with respect to a support surface of the forming machine on either respective side of the conveyor belt, respectively, said translation group further comprising a pair of supporting bars adapted to connect to each other the free ends of the first pair of uprights and of the second pair of uprights, said translation axis being operationally connected to the pair of supporting bars.

10. Method for forming a layer of objects moving forward on a conveyor belt having a forward movement direction, said conveyor belt having a respective operational moving speed, said method comprising the steps of:
providing, by means of counting means operationally associated to the conveyor belt, information representative of the number of objects moving forward on the conveyor belt;
providing means for moving the objects forward on the conveyor belt, operationally associated to the conveyor belt to define a first area and a second area for moving the objects forward on the conveyor belt, the forward movement direction of the conveyor belt being such as to convey the objects from the first forward moving area to the second forward moving area, said moving means being configured to allow/prevent the objects from passing from the first forward moving area to the second forward moving area, based upon the information provided by said counting means;
translating said moving means along the forward movement direction of the conveyor belt, in the forward movement direction of the objects on the conveyor belt, from a first operational position to a second operational position, bringing the translation speed of the moving means from a substantially zero value to a value substantially equal to the operational moving speed of the conveyor belt,
when the moving means are in the second operational position, preventing the objects, by means of said moving means, from passing from the first forward moving area to the second forward moving area of the conveyor belt based upon the information provided by the counting means;
translating said moving means, along the forward movement direction of the conveyor belt, in the forward movement direction of the objects on the conveyor belt, from the second operational position to a third operational position, bringing the translation speed from the value substantially equal to the operational moving speed of the conveyor belt to a value lower than said operational moving speed of the conveyor belt.

11. Method for forming according to claim 10, further comprising the step of translating said moving means, along the forward movement direction of the conveyor belt, in the forward movement direction of the objects on the conveyor belt, from the third operational position to a fourth operational position, bringing the translation speed from the value lower than the operational moving speed of the conveyor belt to the operational moving speed of the conveyor belt.

12. Method for forming according to claim 11, comprising the steps of:
when the moving means are in the fourth operational position allowing the objects, by means of said moving means, to pass from the first forward moving area to the second forward moving area of the conveyor belt;
translating said moving means, along the forward movement direction of the conveyor belt, in an opposite direction to the forward movement direction of the objects on the conveyor belt, from the fourth operational position to the first operational position.
